(19) United States
(12) Patent Application Publication
(10) Pub. No.: US 2025/0033963 A1
(43) Pub. Date: Jan. 30, 2025

(54) HYDROGEN RECOVERY SYSTEM AND METHOD

(71) Applicant: Edwards Vacuum LLC, Sanborn, NY (US)

(72) Inventor: Zachary William Dunbar, Beaverton, OR (US)

(21) Appl. No.: 18/704,759

(22) PCT Filed: Nov. 30, 2022
(86) PCT No.: PCT/IB2022/061585

§ 371 Date: Apr. 25, 2024

(30) Foreign Application Priority Data
Dec. 1, 2021 (GB) 2117327.3

(51) Int. Cl. C01B 3/50; C25B 9/19; C25B 15/025

(52) U.S. Cl. CPC C01B 3/50; C25B 9/19; C25B 15/025

(57) ABSTRACT

Aspects of the present disclosure relate to hydrogen recovery system (1) for extracting hydrogen from process gases. The hydrogen recovery system (1) may include an electrochemical pump (11) for extracting at least some of the hydrogen occurring in the process gases. The electrochemical pump (11) has an anodic compartment (13) having at least one anode (14), a cathodic compartment (15) having at least one cathode (16), and a membrane (17) disposed between the anodic compartment (13) and the cathodic compartment (15). A controller (59) is provided for controlling electric current supplied to the electrochemical pump (11). The anodic compartment (13) has an anodic compartment inlet (23) for introducing the process gases into the anodic compartment (13); and an anodic compartment outlet (25) for discharging a waste gas from the anodic compartment (13). The cathodic compartment (15) has a cathodic compartment outlet (27) for discharging hydrogen extracted from the process gases.

This application is a national stage entry under 35 U.S.C. § 371 of International Application No. PCT/IB2022/061585, filed Nov. 30, 2022, which claims the benefit of GB Application No. 2117327.3, filed Dec. 1, 2021, the entire contents of each of which are incorporated herein by reference.

### TECHNICAL FIELD

The present disclosure relates to a hydrogen recovery system and method. The hydrogen recovery system may be configured to remove at least some of the hydrogen present in a process gas. Aspects of the disclosure relate to a vacuum system, an electrochemical pump and a method of recovering hydrogen from process gases.

### BACKGROUND

Vacuum and abatement systems often comprise a vacuum pump which, in use, exhaust process gases at atmospheric pressure. The vacuum pump may, for example, be a dry pump. The operation of the vacuum pump to exhaust the process gases at atmospheric pressure may include a high power consumption. This is particularly relevant in vacuum systems pumping large quantities of gases. By way of example, a vacuum system for extreme ultraviolet (EUV) lithography may pump a large quantity of hydrogen. The hydrogen is typically exhausted at atmospheric pressure and diluted with air at atmospheric pressure.

### SUMMARY OF THE INVENTION

Aspects and examples of the disclosure provide a hydrogen recovery system, a vacuum system, an electrochemical pump and a method of recovering hydrogen from process gases as claimed in the appended claims.

According to an aspect of the present disclosure there is provided a vacuum system according to claim 1.

In accordance with the present disclosure, the process gases are supplied at a sub-atmospheric pressure. The hydrogen recovery system is used in conjunction with a vacuum system. The process gases from the vacuum system are supplied to the hydrogen recovery system. The process gases are exhausted to the hydrogen recovery system at a pressure which is less than atmospheric pressure. By exhausting the process gases at a sub-atmospheric pressure, the power consumption of the vacuum system may be reduced. It is believed that power savings of greater than 50% may be achieved for operating a dry pump in a vacuum system. In addition, in a hydrogen system, such as an extreme ultraviolet (EUV) system, the need for nitrogen purge gas may be reduced or eliminated. The process gases may be supplied to the hydrogen recovery system at a pressure less than or equal to one of the following: 700 mbar, 600 mbar, 500 mbar, 400 mbar, 300 mbar or 200 mbar.

By coupling an electrochemical pump to the exhaust of a EUV dry pump, the exhaust pressure of the vacuum pump may be reduced, for example to enable more efficient pumping of hydrogen with an exhaust output of approximately 200 mbar. At least in certain examples, this may reduce power consumption and/or may eliminate the need for performing a nitrogen purge. The electrochemical pump may function as a final stage and may be operative to compress the hydrogen to atmospheric pressure or above. The hydrogen recovered by the hydrogen recovery system may be recycled into a customer hydrogen network, if desired. The hydrogen recovery system may comprise a drier for drying the recovered hydrogen gas prior to use in the vacuum system.

The process gases may comprise a mixture of gases. The process gases comprise hydrogen which may be mixed with one or more other gases. In use, the hydrogen recovery system is operative to remove at least some of the hydrogen from the process gases. The hydrogen is removed from the process gases and may be re-used, for example in an industrial process. The treated process gases may be waste gases which are output to an abatement system. The hydrogen recovery system may remove at least 80% of the hydrogen form the process gases. The process gases may be output from a vacuum system. The vacuum system may be operative to establish a vacuum for an industrial process, for example relating to the fabrication of semiconductors. The industrial process may, for example, be extreme ultraviolet (EUV) lithography.

The electrochemical pump comprises an electrochemical hydrogen pump (compressor) for pumping hydrogen through electrochemical processes.

The controller is configured to control operation of the electrochemical pump to control the recovery of hydrogen from the process gases. The controller may be configured to control the electric current supplied to the electrochemical pump, for example by a direct current (DC) power supply. The controller may control the potential difference between the at least one anode and the at least one cathode. The controller may control the electric field density across the membrane.

The electrochemical pump is operable to remove at least some of the hydrogen present in the process gases. The hydrogen content of the process gases is thereby reduced. A waste gas collects in the anode compartment. The waste gas comprises a lower hydrogen content than the process gases supplied to the electrochemical pump. The waste gas may be output to an abatement unit.

The process gases may be supplied at a process gas supply pressure. The process gas supply pressure may be less than atmospheric pressure (i.e., less than one (1) bar).

The hydrogen recovery system may comprise an inlet pressure sensor for measuring an anodic compartment inlet pressure at the anodic compartment inlet. The anodic compartment inlet pressure may correspond to the process gas supply pressure. The inlet pressure sensor may be configured to output an anodic compartment inlet pressure signal to the controller indicating the anodic compartment inlet pressure. Alternatively, or in addition, the hydrogen recovery system may comprise an outlet pressure sensor for measuring an anodic compartment outlet pressure. The outlet pressure sensor may be configured to output an anodic compartment outlet pressure signal to the controller indicating the anodic compartment outlet pressure.

The hydrogen may be discharged from the cathodic compartment at a cathodic compartment outlet pressure. The cathodic compartment outlet pressure may be greater than the anodic compartment inlet pressure. The cathodic compartment outlet pressure may be greater than atmospheric pressure, for example greater than 5 bar. The cathodic compartment outlet pressure may be greater than or equal to 8 bar. In certain examples, the cathodic compartment outlet pressure may be greater than or equal to 10 bar.

The controller may be configured to control operation of the electrochemical pump in dependence on at least one of the anodic compartment inlet pressure and the anodic compartment outlet pressure. The controller may use the anodic compartment inlet pressure and the anodic compartment outlet pressure to help prevent the anode of the electrochemical pump from extracting excessive hydrogen from the process gases. By controlling operation of the electrochemical pump, the efficiency of the electrochemical process at the anode may be maintained. The controller may be configured to control operation of the electrochemical pump in dependence on a pressure differential between the anodic compartment inlet pressure and the anodic compartment outlet pressure. If the pressure differential between the anodic compartment inlet pressure and the anodic compartment outlet pressure increases beyond a predetermined threshold, the controller reduces the electrical current and/or the voltage supplied to the electrochemical pump. This control helps to ensure an adequate supply of hydrogen to the at least one anode.

The controller may be configured to determine an electric current set-point and/or a voltage set-point for the electrochemical pump. The electric current set-point and/or the voltage set-point may be determined in dependence on at least one of the anodic compartment inlet and outlet pressures. The controller may be configured to determine the electric current set-point and/or the voltage set-point for the electrochemical pump in dependence on a pressure differential between the anodic compartment inlet pressure and the anodic compartment outlet pressure.

The controller may be configured selectively to increase and decrease the electrical current and/or the voltage supplied to the electrochemical pump.

The controller may be configured to control operation of the electrochemical pump in dependence on a determination that at least one of the anodic compartment inlet pressure and the anodic compartment outlet pressure is less than a predetermined pressure threshold. The controller may be configured to control operation of the electrochemical pump in dependence on a determination that the anodic compartment inlet pressure and the anodic compartment outlet pressure are less than a predetermined pressure threshold. The controller may be configured to reduce an electric current and/or a voltage supplied to the electrochemical pump in dependence on a determination that at least one of the anodic compartment inlet pressure and the anodic compartment outlet pressure is less than a predetermined pressure threshold. The controller may reduce the electric current and/or the voltage by a predetermined amount or by a predetermined proportion. For example, the electric current supplied to the electrochemical pump may be reduced by 1% in dependence on a determination that the anodic compartment inlet and outlet pressures are below a pressure threshold of 250 mbar.

The controller may be configured to control operation of the electrochemical pump in dependence on a determination that at least one of the anodic compartment inlet pressure and the anodic compartment outlet pressure is greater than a predetermined pressure threshold. The controller may be configured to control operation of the electrochemical pump in dependence on a determination that the anodic compartment inlet pressure and the anodic compartment outlet pressure are greater than a predetermined pressure threshold. The controller may be configured to increase an electric current and/or a voltage supplied to the electrochemical pump in dependence on a determination that at least one of the anodic compartment inlet pressure and the anodic compartment outlet pressure is greater than a predetermined pressure threshold. The controller may increase the electric current and/or the voltage by a predetermined amount or by a predetermined proportion. For example, the electric current supplied to the electrochemical pump may be increased by 1% in dependence on a determination that the anodic compartment inlet and outlet pressures are above a pressure threshold of 250 mbar.

The controller has been described as controlling operation of the hydrogen recovery system in dependence on one or more measured pressures. Alternatively, or in addition, the controller may be configured to control operation of the hydrogen recovery system in dependence on at least one mass flow rate. For example, the controller may be configured to control the electrical current supplied to the electrochemical pump in dependence on a mass flow rate of the hydrogen recovered by the electrochemical pump. Other control techniques are also contemplated.

The hydrogen recovery system may comprise a mass flow meter (MFM) for measuring the mass flow of the hydrogen from the cathodic compartment. The controller may be configured to determine an electric current set-point for the electrochemical pump in dependence on the mass flow of the hydrogen. The electric current can be controlled to maintain steady-state operation of the hydrogen recovery system. A base current may be determined corresponding to two electrons input for one hydrogen molecule output from the electrochemical pump. A supplementary (gain) current may be added to the base current to maintain steady-state operation.

The hydrogen recovery system may comprise an auxiliary pump in fluid communication with the anodic compartment outlet. The auxiliary pump may be operable to pump the process gases through the anodic compartment. The auxiliary pump may be operable to increase the pressure in the anodic compartment outlet. The outlet pressure of the auxiliary pump may be greater than the pressure at the anodic compartment outlet. The outlet pressure of the auxiliary pump may be approximately atmospheric pressure (1 bar). The controller may be configured to activate the auxiliary pump during start-up of the hydrogen recovery system. The controller may be configured to de-activate the auxiliary pump during steady-state operation of the hydrogen recovery system.

The hydrogen recovery system may comprise an auxiliary pump inlet pressure sensor for measuring the inlet pressure of the auxiliary pump. The controller may be configured to control operation of the auxiliary pump in dependence on the inlet pressure of the auxiliary pump. The controller may be configured to re-start the process in dependence on a determination that the inlet pressure of the auxiliary pump is greater than a predetermined upper threshold. A re-start of the hydrogen recovery process may comprise supplying nitrogen to a vacuum pump disposed upstream of the hydrogen recovery system.

The hydrogen recovery system may comprise a throttle valve for controlling the discharge of the waste gas from the anodic compartment to the auxiliary pump. The controller may be configured to control the throttle valve in dependence on the anodic compartment outlet pressure or an inlet pressure of an auxiliary pump. The controller may be configured to control the throttle valve to maintain the pressure of the waste gas at least substantially equal to a predetermined pressure set point. The throttle valve may be adjustable selectively to increase and decrease the flow rate of the waste gas from the anodic compartment.

The hydrogen recovery system may comprise a supply channel to supply an inert gas to the auxiliary pump to facilitate pumping of the process gases through the anodic compartment.

The hydrogen recovery system may comprise at least one valve operable to isolate the auxiliary pump from the anodic compartment outlet. The at least one valve may comprise first and second valves in a parallel configuration.

The controller may be configured to operate the auxiliary pump and selectively to open one or more of the at least one valve to purge impurities. The auxiliary pump may be operated to reduce the inlet pressure. The controller may pulse the opening of the at least one valve to purge impurities.

The hydrogen recovery system may comprise a control (bypass) valve for selectively bypassing the auxiliary pump wherein the controller is configured to actuate the control valve to bypass the auxiliary pump for steady-state operation of the hydrogen recovery system. The control valve may comprise a three-way valve.

The steady-state operation of the hydrogen recovery system may correspond to operation at a predefined pressure or within a predefined pressure range.

The controller may be configured to output a control signal to control the supply of an inert gas. The controller may be configured to output a control signal to inhibit the introduction of the inert gas into the vacuum system during steady-state operation of the hydrogen recovery system. The inert gas may, for example, be nitrogen. At least in certain examples, the quantity of nitrogen introduced into the process gases upstream of the hydrogen recovery system may be reduced.

The hydrogen recovery system may comprise a flow restrictor operable to control the rate at which the gas is discharged from the anodic compartment outlet. The flow restrictor applicable to enable deadheaded running.

The vacuum pump may be a dry pump. The vacuum system may be an extreme ultraviolet (EUV) system. The EUV system may be operative to perform an EUC process, such as EUV lithography.

According to a further aspect of the present disclosure there is provided a method of recovering hydrogen from process gases using an electrochemical pump according to claim 16.

The method may comprise controlling the electrical current supplied to the electrochemical pump to control the recovery of hydrogen from the process gases.

The method may comprise controlling the supply of an inert gas into the process gases. The method may comprise inhibiting the introduction of the inert gas into the process gases when the electrochemical pump is operating under steady-state conditions. The inert gas may, for example, be nitrogen. At least in certain examples, the quantity of nitrogen introduced into the process gases upstream of the hydrogen recovery system may be reduced.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

### BRIEF DESCRIPTION OF DRAWINGS

One or more examples of the disclosure will now be described, by way of example only, with reference to the accompanying drawings.

FIG. 1 shows a schematic representation of a hydrogen recovery system according to a first example of the present disclosure operating in a start-up mode.

FIG. 2 shows a schematic representation of the hydrogen recovery system shown in FIG. 1 operating in a steady-state mode.

FIG. 3 shows a schematic representation of a controller for controlling operation of the hydrogen recovery system shown in FIGS. 1 and 2.

FIG. 4 shows a schematic representation of the electrochemical pump of the hydrogen recovery system shown in FIGS. 1 and 2.

FIG. 5 is a first block diagram providing a schematic representation of the operation of the hydrogen recovery system according to an example of the present disclosure.

FIG. 6 shows a schematic representation of a hydrogen recovery system according to a second example of the present disclosure operating in a start-up mode.

FIG. 7 shows a schematic representation of the hydrogen recovery system shown in FIG. 5 operating in a steady-state mode.

### DETAILED DESCRIPTION

A hydrogen recovery system 1 in accordance with an example of the present disclosure will now be described with reference to the accompanying figures. The hydrogen recovery system 1 is configured to extract hydrogen gas (H2) from a mixture of process gases.

The volumetric flow rate of the gas is described herein with reference to a standard litre per minute (SLM or SLPM) of the gas at standard conditions for temperature and pressure (STP).

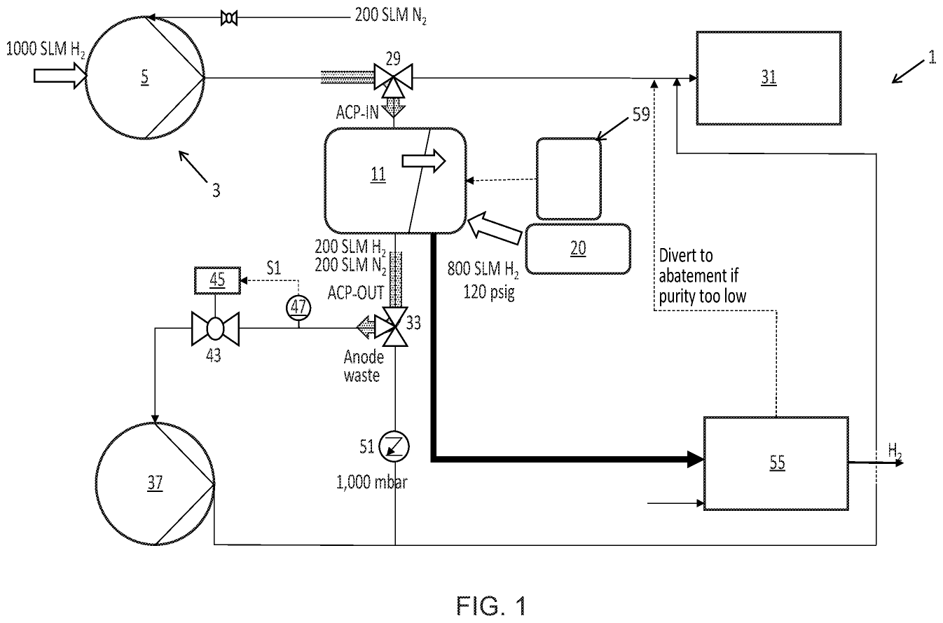

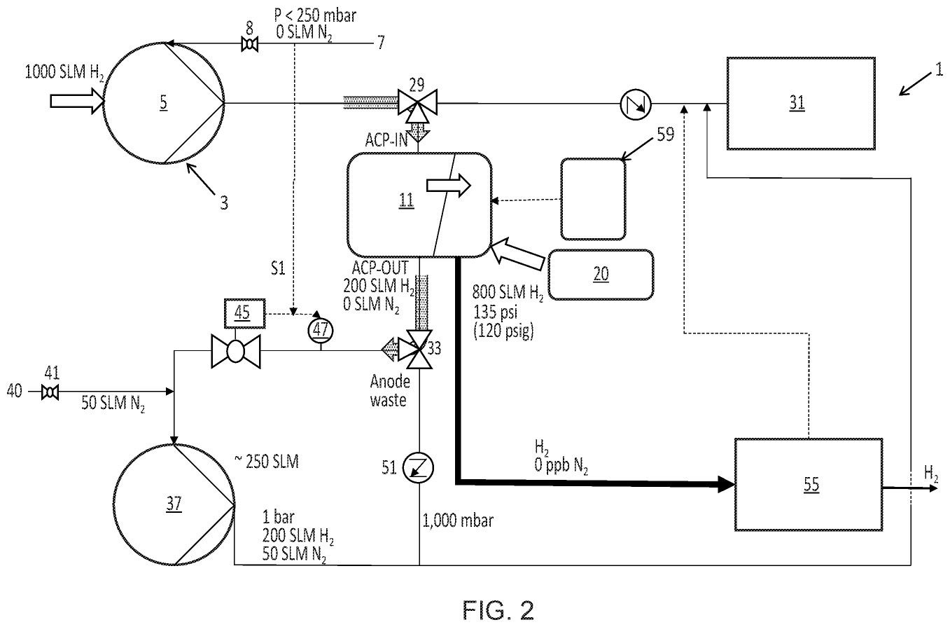

The hydrogen recovery system 1 in the present example is configured to recover hydrogen from process gases exhausted from a vacuum system 3. The process gases are supplied to the hydrogen recovery system 1 at a process gas supply pressure which is less than atmospheric pressure. The hydrogen recovery system 1 is operable in a start-up mode, as illustrated in FIG. 1; and a steady-state mode, as illustrated in FIG. 2. The vacuum system 3 in the present example is an extreme ultraviolet (EUV) system and is configured to establish a vacuum in a working chamber (not shown) for performing an EUV process, such as EUV lithography. The vacuum system 3 may be used in other applications. For example, the vacuum system 3 may be used in semiconductor etching processes or chemical vapour deposition (CVD) processes. The hydrogen recovery system 1 may be incorporated into the vacuum system 3. In the present example, the hydrogen recovery system 1 is a separate system which is connected to the vacuum system 3.

The vacuum system 3 comprises a system vacuum pump 5. The vacuum pump 5 may, for example, be a dry pump. The vacuum pump 5 is operative to pump process gases from the vacuum system 3. The vacuum system 3 in the present example is an EUV system which is dependent on hydrogen gas. The resulting process gases exhausted from the vacuum pump 5 of the vacuum system 3 are composed primarily of hydrogen gas. However, the process gases exhausted from the EUV system may be contaminated with other process gases. For example, the process gases may comprise nitrogen supplied to the vacuum pump 5 to facilitate pumping. The mixture of hydrogen and other process gases are referred to herein as “process gases”. In the present example, the process gases are introduced into the hydrogen recovery system 1 at a flow rate of 1000 SLM. The vacuum pump 5 in the present example comprises a first pumping gas source 7 for selectively introducing an inert gas, such as Nitrogen (N2), to facilitate pumping. A first gas supply valve 8 is provided to control the supply of gas from the first pumping gas source 7. The first pumping gas source 7 is configured to introduce Nitrogen (N2) gas into the vacuum pump 5 at 200 SLM. The hydrogen recovery system 1 may optionally comprise a reservoir 9 for storing the process gases expelled from the vacuum pump 5. The reservoir 9 is not present in the example shown in FIG. 1.

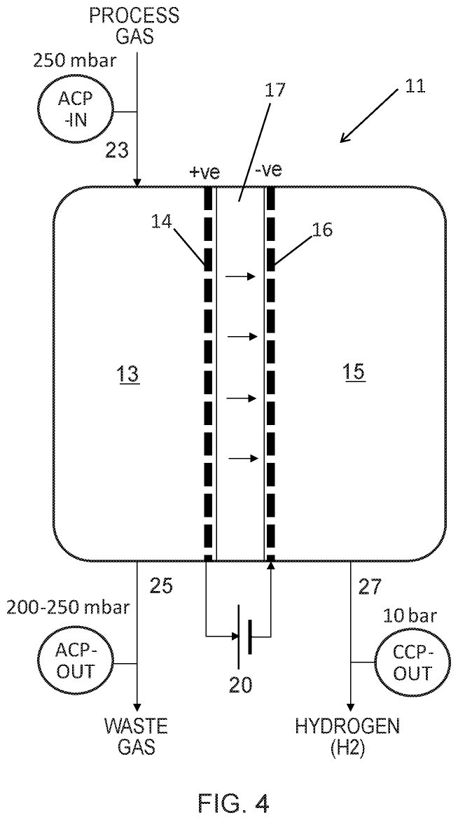

The hydrogen recovery system 1 comprises an electrochemical pump 11 for extracting hydrogen from the process gases. The electrochemical pump 11 is an electrochemical hydrogen pump (compressor) for pumping hydrogen through an electrochemical process. The electrochemical pump 11 comprises a single stage stack. In a variant, the electrochemical pump 11 may comprise a plurality of stages. The electrochemical pump 11 comprises an anodic compartment 13 having at least one anode 14, a cathodic compartment 15 having at least one cathode 16, and a membrane 17 disposed between the anodic compartment 13 and the cathodic compartment 15. The membrane 17 is an electrochemical membrane which may be a polymer membrane. The membrane 17 may, for example, comprise one or more of the following: a polybenzimidazole (PBI) membrane, a proton-doped hydrocarbon membrane, a solid-acid membrane, such as a caesium dihydrogen phosphate membrane or a perfluorosulfonic acid-based membrane. The membrane 17 may be composed of Nafion (TM). A direct current (DC) power supply 20 is provided for supplying current and voltage to the EC pump 11. A schematic representation of the electrochemical pump 11 is shown in FIG. 4. In a variant, the hydrogen recovery system 1 may comprise more than one anodic compartment 13 and/or more than one cathodic compartment 15. The anodic compartment 13 comprises an anodic compartment inlet 23 for receiving the process gases from the vacuum pump 5; and an anodic compartment outlet 25 for discharging a waste gas having a reduced hydrogen content. The waste gas can be referred to as the anode waste. The cathodic compartment 15 comprises a cathodic compartment outlet 27 for discharging the hydrogen separated from the process gases.

The process gases are introduced into the anodic compartment 13 of the electrochemical pump 11 at an anodic compartment inlet pressure ACP-IN. The waste gas is discharged from the anodic compartment 13 at an anodic compartment outlet pressure ACP-OUT. To reduce the pressure drop across the electrochemical pump 11, larger than normal flow field cross-sections may be utilized. The gas diffusion layer may be designed to maximize porosity and therefore minimize pressure drop. The temperature of the electrochemical pump 11 may operate cooler than normal electrochemical pumps, to minimize water evaporation from the proton conducting membrane. If large amounts of water evaporate, it may block hydrogen diffusion into the gas diffusion layer and catalyst layer. The electrochemical pump 11 may optionally comprise a heat exchanger. The heat exchanger may provide cooling of the membrane 17, for example to reduce or prevent condensation. The at least one anode 14 and/or the at least one cathode 16 may comprise one of the following: platinum group metal particles, and carbon-supported platinum group metal particles. Different anode catalysts may be used, as the low partial pressure of hydrogen will create mass transfer overpotentials more readily than normal electrochemical pumping systems. A humidification scheme may rely on direct cathode water injection to limit anode water content.

A first control valve 29 is provided for selectively supplying the process gases from the vacuum pump 5 to the electrochemical pump 11. The first control valve 29 comprises a three-way valve in the present example. The first control valve 29 is operative to supply the process gases to the anodic compartment inlet 23 of the electrochemical pump 11 or to an abatement unit 31.

The waste gas is discharged from the electrochemical pump 11 through the anodic compartment outlet 25. The waste gas in the present example comprises a mixture of hydrogen and nitrogen. The hydrogen component may have a flow rate of 200 SLM, and the nitrogen may have a flow rate of 200 SLM. A second control valve 33 is provided for controlling the waste gas discharged from the anodic compartment outlet 25 of the electrochemical pump 11. The second control valve 33 comprises a three-way valve in the present example. The second control valve 33 is disposed in an outlet channel 35 connected to the anodic compartment outlet 25. The second control valve 33 is operative selectively to connect the anodic compartment outlet 25 to an auxiliary vacuum pump 37. The second control valve 33 can be configured to bypass the auxiliary vacuum pump 37, for example during steady-state operation. The auxiliary vacuum pump 37 comprises an auxiliary vacuum pump inlet 38 in fluid communication with the anodic compartment outlet 25; and an auxiliary vacuum pump outlet 39 in fluid communication with the abatement unit 31. The auxiliary vacuum pump 37 is operative to pump the process gases through the anodic compartment 13, and to pump the waste gas to the abatement unit 31. Alternatively, at least some of the waste gases may be recirculated through the electrochemical pump 11 or supplied to another electrochemical pump 11 for further processing. The auxiliary vacuum pump 37 is illustrated as a dedicated pump in the present example. In a variant, the hydrogen recovery system 1 may use another vacuum pump in the vacuum system 3 or a related abatement system. The hydrogen recovery system 1 may thereby “piggy-back” on an existing vacuum pump to pump the process gases through the electrochemical pump 11. A second pumping gas source 40 is provided for selectively supplying an inert gas, such as nitrogen, to the auxiliary vacuum pump 37. A second gas supply valve 41 is provided for controlling the supply of gas from the second pumping gas source 40 to the auxiliary vacuum pump 37.

A throttle valve 43 is provided on the inlet side of the auxiliary vacuum pump 37 to control the pressure of the waste gas in the anodic compartment outlet 25. A controller 45 is provided for controlling operation of the throttle valve 43. The controller 45 in the present example comprises a proportional-integral-derivative (PID) controller, but other types of controller are contemplated. The controller 45 receives an outlet pressure signal SP-OUT from an outlet pressure sensor 47 configured to measure the anodic compartment outlet pressure ACP-OUT. The controller 45 may optionally also receive an inlet pressure signal SP-IN from an inlet pressure sensor (not shown in this example) configured to measure the anodic compartment inlet pressure ACP-IN. The controller 45 is configured to control the throttle valve 43 to maintain the anodic compartment outlet pressure ACP-OUT at a set-point (target) pressure. In the present example, the set-point pressure is predefined as 250 mbar. A higher or lower set-point pressure may be defined. The controller 45 selectively opens and closes the throttle valve 43 to maintain the anodic compartment outlet pressure ACP-OUT at least substantially equal to the set-point pressure. Alternatively, the controller 45 may control the throttle valve 43 to maintain the anodic compartment outlet pressure ACP-OUT within a target pressure range. The second control valve 33 is operative selectively to connect the anodic compartment outlet 25 to a bypass channel 49 for bypassing the auxiliary vacuum pump 37. A check valve 51 is provided to provide one-way flow of the gas through the bypass channel 49. The bypass channel 49 is connected to the abatement unit 31 for abatement of the waste gas.

The electrochemical pump 11 is operative to extract and compress the hydrogen from the process gases. The hydrogen is collected at the at least one cathode 16 disposed in the cathodic compartment 15. The hydrogen is discharged from the electrochemical pump 11 through the cathodic compartment outlet 27. The hydrogen is discharged from the cathodic compartment 15 at a cathodic compartment outlet pressure CCP-OUT. In the present example, the hydrogen is discharged from the cathodic compartment outlet 27 with a flow rate of 800 SLM and a cathodic compartment outlet pressure CCP-OUT of approximately 135 psi (931 kPa) (approximately 120 psig). An outlet channel 53 is connected to the cathodic compartment outlet 27 for conveying the hydrogen to a blender box 55. The hydrogen is accumulated in the blender box 55 and may subsequently be used in the EUV process. If the purity of the hydrogen collected in the blender box 55 is too low, the blender box 55 may be connected to the abatement unit 31. The hydrogen in the blender box 55 may optionally be supplemented from an external source, for example to maintain an adequate supply for the EUV process.

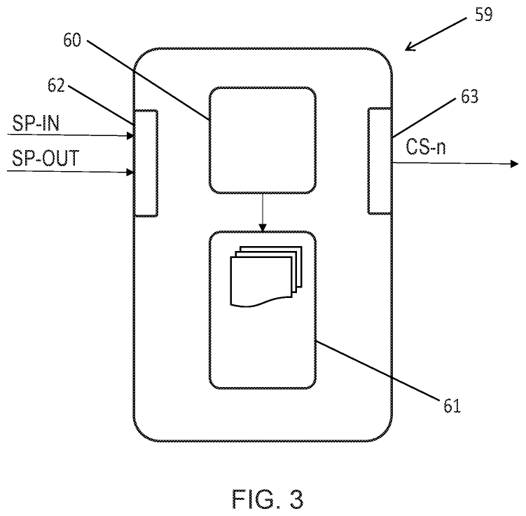

The hydrogen recovery system 1 comprises a controller 59. As shown in FIG. 3, the controller 59 is an electronic control unit (ECU) comprising at least one electronic processor 60 and a memory device 61. The at least one electronic processor 60 is configured to execute a set of computational instructions stored on the memory device 61 to perform the method(s) described herein. The electronic processor 60 has at least one electrical input 62 for receiving one or more sensor signal; and at least one electrical output 63 for outputting one or more control signal CS-n. The controller 59 is configured to control operation of the electrochemical pump 11. In particular, the controller 59 is configured to control the electric current and/or the voltage supplied to the electrodes of the electrochemical pump 11 by the power supply 20. The controller 59 is configured to determine an electric current set-point and/or a voltage set-point for the electrochemical pump 11. The controller 59 controls the power supply 20 such that the electric current supplied to the electrochemical pump 11 is at least substantially equal to the determined electric current set point. Alternatively, the controller 59 controls the power supply 20 such that the voltage supplied to the electrochemical pump 11 is at least substantially equal to the determined voltage set point. As described herein, the controller 59 may increase or decrease the electric current set-point and/or the voltage set-point in dependence on one or more operating parameter of the hydrogen recovery system 1. The controller 59 is configured also to control the first control valve 29, the second control valve 33 and the auxiliary vacuum pump 37. The controller 59 is configured to control the supply of nitrogen to at least one of the vacuum pump 5 and the auxiliary vacuum pump 37.

In use, the vacuum pump 5 is configured to exhaust gases at sub-atmospheric pressure, for example less than or equal to 200 mbar or 300 mbar. This contrasts with prior art arrangements in which a corresponding pump would typically be configured to exhaust at atmospheric pressure. The electrochemical pump 11 functions as an additional (final) pump stage and extracts the hydrogen present in the process gases exhausted from the vacuum pump 5. The electrochemical pump 11 is operative to compress the hydrogen extracted from the process gases. At least in certain examples, the electrochemical pump 11 may compress the hydrogen to greater than or equal to atmospheric pressure.

The controller 59 is configured to control the hydrogen recovery system 1 to operate in a start-up mode and a steady-state mode. The start-up mode may be initiated while the vacuum system 3 is operating or may be initiated before activation of the vacuum system 3. The start-up mode comprises energising the electrochemical pump 11. A potential difference is established between the at least one anode 14 and the at least one cathode 16. The controller 59 controls the current set-point to control operation of the electrochemical pump 11. The controller 59 configures the first control valve 29 to direct the process gases from the vacuum system 3 into the anodic compartment 13 of the electrochemical pump 11. The controller 59 activates the auxiliary vacuum pump 37 and configures the second control valve 33 to direct the waste gas from the vacuum system 3 to the auxiliary vacuum pump 37. The auxiliary vacuum pump 37 is operative to pump the process gases through the electrochemical pump 11. The waste gas is discharged from the anodic compartment 13 and pumped to the abatement unit 31. The controller 59 in the present example is configured to supply nitrogen to the vacuum pump 5 during the start-up mode. The nitrogen may, for example, be supplied at a flow rate of 200 SLM.

The controller 59 determines that the start-up mode is complete when the pressure in the anodic compartment outlet channel 35 reaches a predetermined set-point and/or is at least substantially constant (i.e., the HRC 1 is operating in a steady-state condition). In the present example, the controller 59 determines that the start-up mode is complete when the pressure in the anodic compartment outlet channel 35 is less than 250 mbar. In dependence on this determination, the controller 59 transitions to operation in the steady-state mode. The PID controller 45 controls the throttle valve 43 to maintain the pressure in the anodic compartment outlet 25 at least substantially equal to the set-point pressure. In the present example, the set-point pressure is defined as 250 mbar. The set-point pressure may be greater than or less than 250 mbar. The controller 59 is configured at least partially to close the first gas supply valve 8 to reduce or stop the supply of nitrogen from the first pumping gas source 7 when the outlet pressure signal SP-OUT from the outlet pressure sensor 47 indicates that the anodic compartment outlet pressure ACP-OUT is less than a set-point pressure, for example 250 mbar. The controller 59 may optionally be configured to supply nitrogen to the auxiliary vacuum pump 37. In the present example, nitrogen is supplied to the auxiliary vacuum pump 37 at a flow rate of 50 SLM. The auxiliary vacuum pump 37 is operative to achieve or maintain steady-state pumping at a flow rate of approximately 250 SLM. The outlet pressure of the auxiliary vacuum pump 37 may be at least substantially equal to atmospheric pressure. The waste gas is pumped to the abatement unit 31 for abatement.

The electrochemical pump 11 extracts at least some of the hydrogen present in the process gases exhausted from the vacuum pump 5. The extracted hydrogen is collected at the at least one cathode 16 and accumulates in the cathodic compartment 15. The electrochemical pump 11 is operative to pressurise the hydrogen extracted from the process gases. The hydrogen is discharged from the cathodic compartment 15 through the cathodic compartment outlet 27 and collected in the blender box 55. In the present example, the hydrogen has a flow rate of 800 SLM and a cathodic compartment outlet pressure CCP-OUT of approximately 135 psi (931 kPa) (approximately 120 psig).

The hydrogen recovery system 1 according to the present example reduces the output pressure of the vacuum pump 5 and may thereby improve pump efficiency and power savings. By way of example, a power saving of 2 kW per pump may be achieved. The vacuum system 3 may comprise a plurality of pumps, for example five (5) vacuum pumps. The power savings may be available in respect of each pump. The electrochemical pump 11 may enable recover of hydrogen with a high purity with little or no nitrogen impurity. At least in certain examples, the hydrogen recovery system 1 may enable recovery of approximately 80% to 100% of the hydrogen introduced into an EUV system.

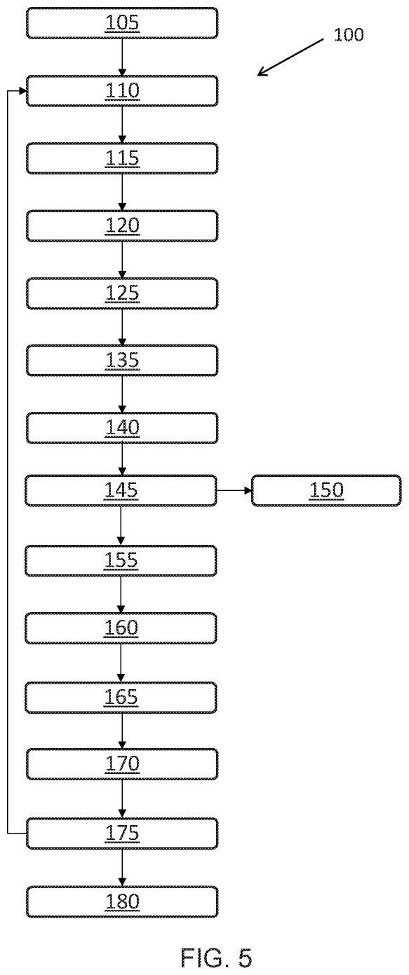

A method of recovering hydrogen from process gases using the hydrogen recovery system 1 will now be described with reference to a first block diagram 100 shown in FIG. 5. The controller 59 is configured to execute the method(s) described herein. As described herein, the hydrogen recovery system 1 comprises an electrochemical (hydrogen) pump (11) having an anodic compartment 13 and a cathodic compartment 15. A membrane 17 is disposed between the anodic compartment 13 and the cathodic compartment 15. The method comprises discharging process gases from a vacuum pump 5 of a vacuum system 3 (BLOCK 105). An inert gas, such as nitrogen, may optionally be introduced into the vacuum pump 5 to facilitate pumping of the process gases (BLOCK 110). An auxiliary vacuum pump 37 disposed on the outlet side of the electrochemical pump 11 is activated. The vacuum system 3 may, for example, be an extreme ultraviolet (EUV) system 3. A first control valve 29 is configured to introduce the process gases into the electrochemical pump 11 (BLOCK 115). A second control valve 33 is configured to direct the waste gases from the electrochemical pump 11 to an auxiliary pump 37 (BLOCK 120). The auxiliary pump 37 is activated (BLOCK 125). The auxiliary pump 37 pumps the process gases through the anodic chamber 13 of the electrochemical pump 11 (BLOCK 125). A throttle valve 45 may optionally be operated to control the supply of the waste gases to the auxiliary pump 37 (BLOCK 130). The throttle valve 45 may be controlled to maintain a set-point pressure for the waste gases supplied to the auxiliary pump 37. The auxiliary pump 37 pumps the wate gases to an abatement unit 31 (BLOCK 135). The electrochemical pump 11 operates to filter at least some of the hydrogen gas present in the process gases (BLOCK 140). The recovered hydrogen is discharged from the cathodic compartment 15 (BLOCK 145), for example to a reservoir (blender box 55) for storage. The method may optionally comprise controlling the electrical current and/or the voltage supplied to the electrochemical pump 11 to control the recovery of hydrogen from the process gases. If the waste gas from the electrochemical pump 11 output to the auxiliary pump 37 at an anodic compartment outlet pressure ACP-OUT less than a predetermined pressure threshold, for example 250 mbar, the supply of nitrogen to the vacuum pump 5 is stopped (BLOCK 150). The pressure threshold may be defined to correspond to steady-state operation of the hydrogen recovery system 1.

During steady-state operation, the second control valve 33 is configured to bypass the auxiliary pump 37 (BLOCK 155). An operating speed of the auxiliary pump 37 may be reduced or the auxiliary pump 37 may be stopped during steady-state operation of the hydrogen recovery system 1 (BLOCK 160). The waste gases from the anodic compartment 13 are sent directly to the abatement unit 31 (BLOCK 165). The check valve 51 may at least substantially inhibit the return of the waste gases to the electrochemical pump 11 (BLOCK 170). The method may comprise re-starting the pumping process, for example if the pressure of the waste gases discharged from the anodic compartment 13 are greater than or less than a predetermined threshold. (BLOCK 175). The method may comprise selectively controlling the supply of waste gases to the auxiliary pump 37 to perform a purge operation, for example comprising pulsing a control valve to provide an intermittent supply of waste gases while the auxiliary pump 37 is operating. The hydrogen recovery process is stopped (BLOCK 180) when the vacuum system 3 is shut down.

The method may comprise selectively increasing and decreasing the electrical current supplied to the electrochemical pump 11. The method may comprise reducing the electrical current supplied to the electrochemical pump 11 in dependence on a determination that at least one of the anodic compartment inlet pressure ACP-IN and the anodic compartment outlet pressure ACP-OUT of the electrochemical pump 11 is less than a predetermined pressure threshold. The method may comprise increasing the electrical current supplied to the electrochemical pump 11 in dependence on a determination that at least one of the anodic compartment inlet pressure ACP-IN and the anodic compartment outlet pressure ACP-OUT of the electrochemical pump 11 is greater than a predetermined pressure threshold.

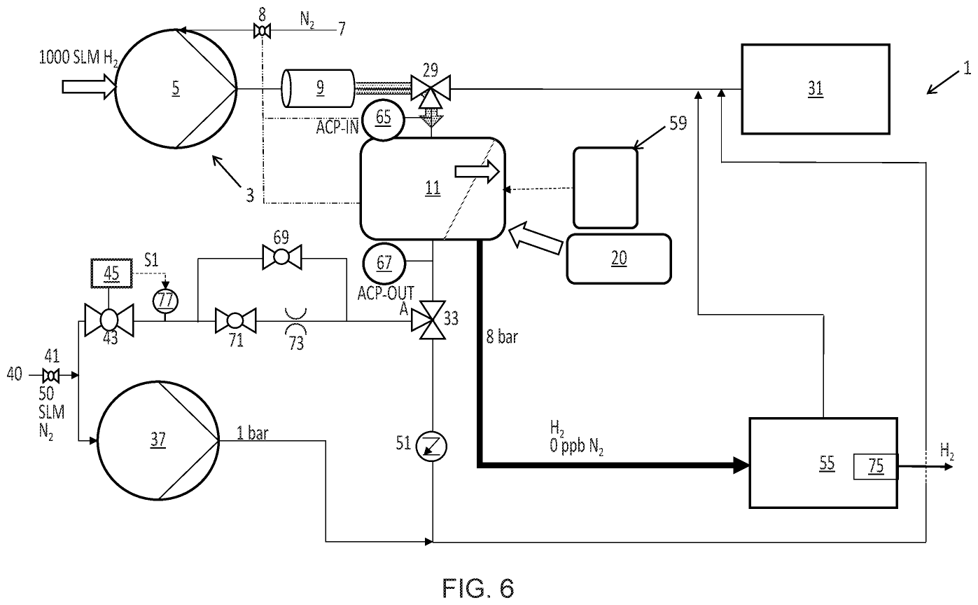

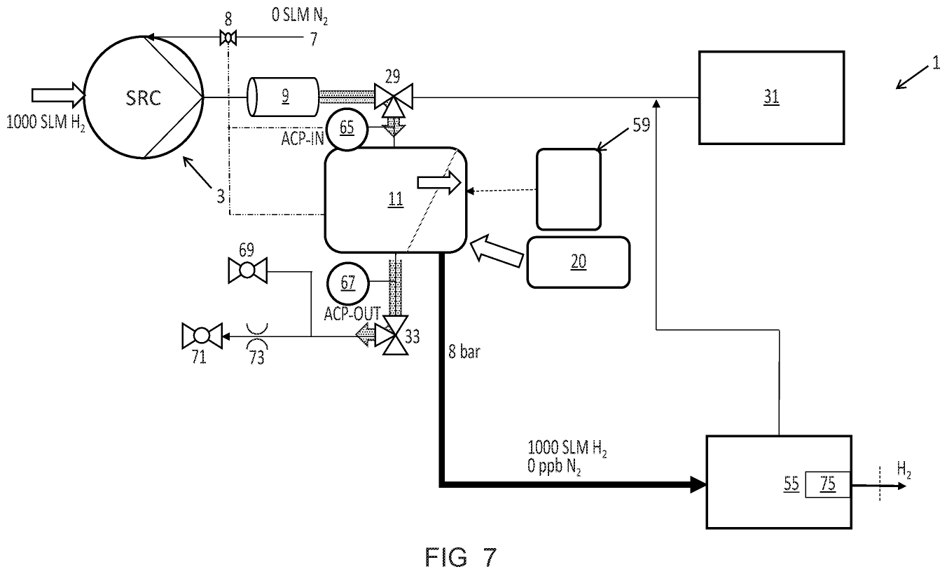

A further example of the hydrogen recovery system I will now be described with reference to FIGS. 6 and 7. The hydrogen recovery system 1 according to the present example is a development of the example shown in FIGS. 1 and 2. Like reference numerals are used for like components.

As shown in FIG. 6, the hydrogen recovery system 1 in this example comprises a reservoir 9 for accumulating the process gases exhausted from the vacuum system 3. The hydrogen recovery system 1 comprises an inlet pressure sensor 65 for measuring the anodic compartment inlet pressure ACP-IN at the anodic compartment inlet 23. The inlet pressure sensor 65 outputs an inlet pressure signal SP-IN to the controller 59. An outlet pressure sensor 67 is provided for measuring the anodic compartment outlet pressure ACP-OUT at the anodic compartment outlet 27. The outlet pressure sensor 67 outputs an outlet pressure signal SP-OUT to the controller 59. The controller 59 is configured to control operation of the electrochemical pump 11 in dependence on at least one of the anodic compartment inlet pressure ACP-IN and the anodic compartment outlet pressure ACP-OUT.

The controller 59 is configured to reduce the current supplied to the electrochemical pump 11 in dependence on a determination that the anodic compartment inlet pressure ACP-IN and the anodic compartment outlet pressure ACP-OUT are less than a predetermined first pressure threshold. The first pressure threshold in the present example is 250 mbar. It will be understood that the first pressure threshold may be greater than or less than 250 mbar. The controller 59 is configured to reduce the current supplied to the electrochemical pump 11 by a predetermined proportion, for example 1%, in dependence on a determination that both the anodic compartment inlet pressure ACP-IN and the anodic compartment outlet pressure ACP-OUT are less than the predetermined first pressure threshold.

The controller 59 is configured to increase the current supplied to the electrochemical pump 11 in dependence on a determination that the anodic compartment inlet pressure ACP-IN and the anodic compartment outlet pressure ACP-OUT are greater than a predetermined second pressure threshold. The second pressure threshold in the present example is 250 mbar. It will be understood that the second pressure threshold may be greater than or less than 250 mbar. The controller 59 is configured to increase the current supplied to the electrochemical pump 11 by a predetermined proportion, for example 1%, in dependence on a determination that both the anodic compartment inlet pressure ACP-IN and the anodic compartment outlet pressure ACP-OUT are greater than the predetermined first pressure threshold.

The anodic compartment outlet channel 35 in the present example comprises first and second outlet control valves 69, 71 disposed in the outlet channel 35 connected to the anodic compartment outlet 25. In the present example, the first and second outlet control valves 69, 71 are disposed between the second control valve 33 and the throttle valve 43. It will be understood that the position of the first and second outlet control valves 69, 71 in the outlet channel 35 may be varied. The first and second outlet control valves 69, 71 each comprise a pneumatic valve in the present example. Other types of valve may be used, such as a solenoid valve. The first and second outlet control valves 69, 71 are arranged in parallel to each other. The actuation of the first and second outlet control valves 69, 71 can be controlled by the controller 59. A flow restrictor 73 is provided in series with the second outlet control valve 71. The flow restrictor 73 enables deadheaded running of the hydrogen recovery system 1.

After reaching a desired operating pressure, for example 250 mbar, the supply of nitrogen to the vacuum pump 5 may be turned off. Under these operating conditions, the gas exiting the vacuum pump 5 is at least substantially pure hydrogen. In this state, the exhaust of the anodic compartment 13 can be completely closed. The anodic compartment 13 in the present example may be closed by closing the first and second outlet control valves 69, 71. Alternatively, or in addition, an independent dedicated on/off valve (not shown) may be provided to close the outlet of the anodic compartment 13. The pressure inside the electrochemical pump 11 will begin to increase. The controller 59 proportionally increases the electric current and/or the voltage supplied to the electrochemical pump 11 until a steady-state condition is reached where incoming hydrogen from the vacuum pump 5 is transported through the electrochemical membrane 17. The extremely pure hydrogen leaving the electrochemical pumps 11 prevents rapid build-up of inert gas components. Occasionally, anodic compartment 13 may undergo venting/purging due to eventual build-up of inert components, such as trace levels of nitrogen. This would be accomplished by temporarily opening the first and second outlet control valves 69, 71 and allowing a temporarily flow of hydrogen (plus trace inert components) to flow out of the anodic compartment 13 and into the process waste line. The advantage of this mode is that nearly 100% of vacuum pump hydrogen would be captured and pressured into the cathodic compartment 15 of the electrochemical pump 11. This could then be recycled back into the original upstream process, creating a “closed loop” of hydrogen. The hydrogen supply may undergo a topping off but, at least in certain examples, this would be reduced. The hydrogen recovery system 1 in accordance with certain aspects of the present disclosure may simplify logistics, costs and/or environmental effects of hydrogen production.

A mass flow meter (MFM) 75 is provided for measuring the mass flow of the hydrogen from the cathodic compartment 15. The MFM 75 outputs a flow rate signal SMF to the controller 59. In the present example the MFM 75 is disposed in the blender box 55. The MFM 75 could be separate from the blender box 55, for example in the outlet of the cathodic compartment 15. The controller 59 is configured to determine an electric current set-point for the electrochemical pump 11 in dependence on the mass flow of the hydrogen. The electric current set-point can be determined to maintain steady-state operation of the hydrogen recovery system 1. The electric current set-point may be determined to provide the desired flow rate of hydrogen from the electrochemical pump 11. The electric current set-point may correspond to the sum of a base (steady-state) electric current and an electric current “gain”. The base electric current for steady-state operation of the hydrogen recovery system 1 corresponds to a mass flow measurement of two (2) electrons input for each one (1) hydrogen molecule pumped. The electric current ‘gain’ may be superimposed on the base electric current. The electric current “gain” may be determined in dependence on a measured pressure at the anodic compartment inlet 23 and/or the anodic compartment outlet 25. The pressure measured at the anodic compartment inlet 23 and/or the anodic compartment outlet 25 may be compared to a predetermined target pressure. Alternatively, or in addition, the pressures measured at the anodic compartment inlet 23 and the anodic compartment outlet 25 may be compared to each other, for example to determine a pressure differential. The controller 59 may be configured to increase the electric current ‘gain’, for example by 1%, if at least one of the pressures measured at the anodic compartment inlet 23 and the anodic compartment outlet 25 is below a predetermined pressure threshold, such as 250 mbar. The controller 59 may be configured to decrease the electric current ‘gain’, for example by 1%, if at least one of the pressures measured at the anodic compartment inlet 23 and the anodic compartment outlet 25 is above a predetermined pressure threshold, such as 250 mbar.

The hydrogen recovery system 1 comprises a controller 45 for controlling operation of the throttle valve 43. An auxiliary pump inlet pressure sensor 77 is provided to measure the inlet pressure of the auxiliary vacuum pump 37. The throttle valve 43 is controlled in dependence on the measured inlet pressure of the auxiliary vacuum pump 37. The controller 59 is configured to control operation of the auxiliary vacuum pump 37 in dependence on the measured pressure at the inlet of the auxiliary vacuum pump 37. In the present example, the controller 59 is configured to re-start the hydrogen recovery process in dependence on a determination that the measured pressure at the inlet of the auxiliary vacuum pump 37 is greater than a predetermined upper threshold, for example 500 mbar. Re-starting the hydrogen recovery system 1 may comprise controlling the first pumping gas source 7 to supply nitrogen to the vacuum pump 5 and/or controlling the second pumping gas source 40 to supply nitrogen to the auxiliary vacuum pump 37.

The operation of the hydrogen recovery system 1 may cause impurities to accumulate in the auxiliary vacuum pump 37 and/or the associated channels. The controller 59 in the present example is configured to implement a purge process for expelling accumulated impurities to waste. The controller 59 closes the first and second outlet control valves 69, 71 and activates the auxiliary vacuum pump 37. At least one of the first and second outlet control valves 69, 71 may be pulsed open to introduce waste gases to the auxiliary vacuum pump 37 to purge accumulated impurities to waste.

In use, the controller 59 is configured to close the first and second outlet control valves 69, 71 when the hydrogen recovery system 1 is operating in a steady-state condition, as shown schematically in FIG. 7. The controller 59 may continue to determine an electric current set-point for the electrochemical pump 11 in dependence on the mass flow rate measured by the MFM 75. During steady-state operation, the controller 59 may control the current supplied to the electrochemical pump 11 in dependence on the measured mass flow rate and at least one of the anodic compartment inlet pressure ACP-IN and the anodic compartment outlet pressure ACP-OUT. For example, the controller 59 may control the current supplied to the electrochemical pump 11 in dependence on the measured mass flow rate and the anodic compartment inlet pressure ACP-IN. During steady-state operation, the controller 59 may deactivate the auxiliary vacuum pump 37.

It will be appreciated that various changes and modifications can be made to the present disclosure without departing from the scope of the present application. For example, a pressure sensor may be provided on the cathodic compartment outlet 27. The controller 59 may be configured to control the electric current set-point for the electrochemical pump 11 in dependence on the pressure measured at the cathodic compartment outlet 27. In certain examples, the auxiliary vacuum pump 37 may be omitted.

The hydrogen recovery system 1 may optionally comprise a drier for drying the recovered hydrogen gas. The drier may, for example, perform a drying operation to enable the hydrogen to be re-introduced into the vacuum system 3.

The present disclosure has been described with particular reference to the extraction of hydrogen from process gases which are supplied at sub-atmospheric pressures. It will be understood that the system and method(s) described herein may be used to recover hydrogen from process gases supplied at pressures greater than or equal to atmospheric pressure.

1. A vacuum system comprising:
a hydrogen recovery system for extracting hydrogen from process gases; and
a vacuum pump operable to supply the process gases to the hydrogen recovery system at a sub-atmospheric pressure;
wherein the hydrogen recovery system comprises:
an electrochemical pump for extracting at least some of the hydrogen occurring in the process gases, the electrochemical pump comprising an anodic compartment having at least one anode, a cathodic compartment having at least one cathode, and a membrane disposed between the anodic compartment and the cathodic compartment;
a controller for controlling operation of the electrochemical pump;
an anodic compartment inlet for introducing the process gases into the anodic compartment;
an anodic compartment outlet for discharging a waste gas from the anodic compartment; and
a cathodic compartment outlet for discharging hydrogen gas extracted from the process gases.

2. A vacuum system as claimed in claim 1 comprising a first pressure sensor for measuring an anodic compartment inlet pressure (ACP-IN) at the anodic compartment inlet; and a second pressure sensor for measuring an anodic compartment outlet pressure (ACP-OUT) at the anodic compartment outlet, wherein the controller is configured to control operation of the electrochemical pump in dependence on at least one of the anodic compartment inlet and outlet pressures (ACP-IN, ACP-OUT).

3. A vacuum system as claimed in claim 2, wherein the controller is configured to control operation of the electrochemical pump in dependence on a pressure differential between the anodic compartment inlet pressure and the anodic compartment outlet pressure (ACP-IN, ACP-OUT).

4. A vacuum system as claimed in claim 2, wherein the controller is configured to reduce electric current or voltage supplied to the electrochemical pump in dependence on a determination that at least one of the anodic compartment inlet pressure and the anodic compartment outlet pressure is less than a predetermined pressure threshold.

5. A vacuum system as claimed in claim 2, wherein the controller is configured to increase electric current or voltage supplied to the electrochemical pump in dependence on a determination that at least one of the anodic compartment inlet pressure and the anodic compartment outlet pressure is greater than a predetermined pressure threshold.

6. A vacuum system as claimed in claim 1 comprising a mass flow meter for measuring mass flow of the hydrogen from the cathodic compartment;
wherein the controller is configured to determine an electric current set-point for the electrochemical pump in dependence on the mass flow of the hydrogen.

7. A vacuum system as claimed claim 1 comprising an auxiliary pump in fluid communication with the anodic compartment outlet, the auxiliary pump being operable to pump the process gases through the anodic compartment.

8. A vacuum system as claimed in claim 7 comprising an auxiliary pump inlet pressure sensor for measuring inlet pressure of the auxiliary pump, wherein the controller is configured to control operation of the auxiliary pump in dependence on the inlet pressure of the auxiliary pump.

9. A vacuum system as claimed in claim 8, wherein the controller is configured to re-start the process in dependence on a determination that the inlet pressure of the auxiliary pump is greater than a predetermined upper threshold.

10. A vacuum system as claimed in claim 7 comprising a throttle valve for controlling the discharge of the waste gas from the anodic compartment to the auxiliary pump.

11. A vacuum system as claimed in claim 8 comprising a gas source for supplying an inert gas to the auxiliary pump to facilitate pumping of the process gases through the anodic compartment.

12. A vacuum system as claimed in claim 8 comprising at least one valve operable to isolate the auxiliary pump from the anodic compartment outlet.

13. A vacuum system as claimed in claim 12, wherein the controller is configured to operate the auxiliary pump and to selectively open one or more of the at least one valve to purge impurities.

14. A vacuum system as claimed in claim 8 comprising a control valve for selectively bypassing the auxiliary pump wherein the controller is configured to actuate the control valve to bypass the auxiliary pump for steady-state operation of the hydrogen recovery system.

15. A vacuum system as claimed in claim 14, wherein the controller is configured to output a control signal to inhibit introduction of an inert gas into the vacuum system during steady-state operation of the hydrogen recovery system.

16. A method of recovering hydrogen from process gases in a vacuum system using an electrochemical pump, the electrochemical pump comprising an anodic compartment having at least one anode, a cathodic compartment having at least one cathode, and a membrane disposed between the anodic compartment and the cathodic compartment;
wherein the method comprises introducing the process gases into the anodic compartment of the electrochemical pump from a vacuum pump at a sub-atmospheric pressure;
discharging a waste gas from the anodic compartment; and
discharging hydrogen gas from the cathodic compartment.

17. A method as claimed in claim 16 comprising:
controlling the electrochemical pump to control the recovery of hydrogen from the process gases.

18. A method as claimed in claim 16 comprising inhibiting introduction of an inert gas into the process gases when the electrochemical pump is operating under steady-state conditions.
